(19) United States
(12) Patent Application Publication
(10) Pub. No.: US 2004/0182254 A1
(43) Pub. Date: Sep. 23, 2004

(54) Rotisserie driven by hot air thermal engine

(76) Inventor: Ezra Gershon, East Meadow, NY (US)

Correspondence Address: Karl F. Milde, Jr., Esq., MILDE, HOFFBERG & MACKLIN, L.L.P., Suite 460, 10 Bank Street, White Plains, NY, 10606, US

(21) Appl. No.: 10/600,036

(22) Filed: Jun. 20, 2003

Related U.S. Application Data
(60) Provisional application No. 60/456,082, filed on Mar. 19, 2003.

(51) Int. Cl. A47J 37/04

(52) U.S. Cl. 99/419; 99/421 H

(57) ABSTRACT

The present invention provides a thermal driven spit for cooking, the spit being driven by the heat supplied for the cooking.

### FIELD OF THE INVENTION

The present invention relates to rotisseries and cooking grills, such as backyard or outdoor barbeque grills; and provides a rotating spit without the need for electricity.

### BACKGROUND OF THE INVENTION

Food cooked on a rotating spit is easily, uniformly heated, without having to turn the food during cooking, or having to open the grill to do so. A rotisserie may provide a rotatable spit, or a powered, rotating spit. Currently, some outdoor gas and charcoal grills are provided with electrical motors to drive, or rotate, the spit. However, electrical outlets are not readily available outdoors. Some rotisseries have mechanical, manual, and spring loaded drives to turn the spit, but these require constant attention. If they stop, it may be necessary to open the grill, assess the loss in uniformity of cooking, and make adjustments. The present invention makes use of the available heat energy used for cooking the food, to drive a thermal engine, which may power a rotisserie spit, and that may also provide power for other usage.

### SUMMARY OF THE INVENTION

The present invention provides a rotisserie with a hot air engine adjacent the cooking region, to rotate the spit using the power of the heat used to cook the food, whether the heat source is a simple charcoal fire, gas flame, or electrical heating element, without requiring a separate electrical source or outlet to power the spit. Thus the present invention provides a powered rotisserie for any cooking grill.

The hot air engine of the rotisserie of the present invention turns an engine shaft located outside of, or peripherally to, the heated cooking region. The engine shaft is attached to a spit shaft, which extends into the heated cooking region. If desired, the spit may have two parts; a spit (the cooking portion) and the spit shaft which may be connected to, and powered by, the engine shaft. The food to be cooked is placed on the rotisserie spit, and the spit connected to a spit shaft in a fixed, rotation preserving connection, such that the turning of the engine shaft rotates the spit shaft and spit which is in the cooking region. The connection of the spit to the spit shaft must also be strong enough to support the food disposed on the spit.

The hot air engine has at least one cylinder, each having an air filled chamber with a drive piston displaceable within the chamber when the air is heated. The drive piston rods, attached to the pistons, extend through the wall of the cylinder, and makes a pivot-able connection to the engine shaft, such that the phased displacement of the drive pistons of the cylinders turns the engine shaft, which rotates the spit shaft.

The heat of the cooking fire heats the air in the chambers. As the air is heated it displaces the drive piston, and the drive piston rod, which moves the engine shaft. The engine shaft drives the spit shaft and spit, in a ratio of, e.g., four turns to one turn in the preferred embodiment.

The rotisserie of the present invention may incorporate its own heat source for cooking, or may be used with an existing heat source. The rotisserie may be constructed as a replacement for an existing grill, with the spit and hot air cylinders within the lid; i.e., within the area defined by the concave under surface of the lid; and the engine shaft disposed peripherally to the convex outer surface of the lid.

At the end of the forward movement (displacement) of the drive piston the cylinder has a relief valve, which opens to vent the hot air, and which may also function as an intake valve, introducing more air into the cylinder chamber. In a preferred embodiment the relief valves are provided with a spring loaded string anchor.

The spring loaded string anchor may have a number of configurations. In one embodiment it comprises a string attached to the engine shaft, and wound between, two wheels rotatable on their respective axes, which define a line generally parallel to the engine shaft, and past the opposite end of the cylinder from the engine shaft. A third wheel, rotatable on its center axis, which is disposed on a slide bar, the outer end of which lies on the said line, said string wound about the third wheel and attached to the end of the cylinder opposite the drive piston. A spring disposed adjacent the third wheel and generally perpendicular to the said line, and attached to the third wheel to urge it away from the cylinder, maintaining the relief valve in a closed position. An engager disposed between the center axis of the third wheel and the cylinder, and capable of displacing the relief valve piston rod, and thereby the piston, so as to open the relief valve when the string tension overcomes the spring and the third wheel moves down the slide bar.

In another preferred embodiment the spring loaded string anchor comprises a string having one end attached to the engine shaft, and the other end attached to a sliding shaft, moveable within a guide tube, attached to the rotisserie generally perpendicular to the engine shaft. The sliding shaft is firmly attached to an engager, spring loaded away from the rotisserie. The engager is attached to the relief piston rods, and capable of displacing the relief valve piston rods, and thereby the piston, so as to open the relief valve when the string tension overcomes the spring and the sliding shaft moves through the guide tube.

In the preferred rotisserie of the present invention, the cylinders and the spit may be located within a lid-type structure, and the engine shaft located outside the lid. If desired the rotisserie may be designed with the cylinders, spit and engine shaft attached to the lid, to replace the lid of an existing grill. When incorporated into a new grill all these features need not be placed within the lid. Alternatively, the rotisserie of the present invention may comprise a stand-alone rotisserie unit, which may be transported to any cooking heat source.

It is an object of the present invention to provide the ease and efficiency of cooking with a powered rotating spit, without requiring a source of electricity. In particular, it is an object of the present invention to provide a rotating spit for an outdoor grill. It is a further object of the present invention to provide a rotisserie for any portable outdoor grill. It is a still further object of the invention to provide a rotisserie as a replacement lid for existing outdoor grills.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a side view in partial cross-section of a preferred embodiment of the rotisserie of the present invention illustrating the cylinders of the thermal engine, and the rotisserie spit under the lid of a grill.

FIG. 2 is a cross sectional view of the cylinders, illustrating their chambers, valves, and pistons, and their connection to the engine shaft and the spring loaded string anchors.

FIG. 3 is a cross-section of the relief valve of a cylinder illustrating a spring loaded string anchor.

FIG. 4 is schematic top view of a quick disconnect means for the rotisserie spit, shown disengaged.

FIG. 5 is top view of another preferred relief valve configuration.

### DESCRIPTION OF THE PREFERRED EMBODIMENTS

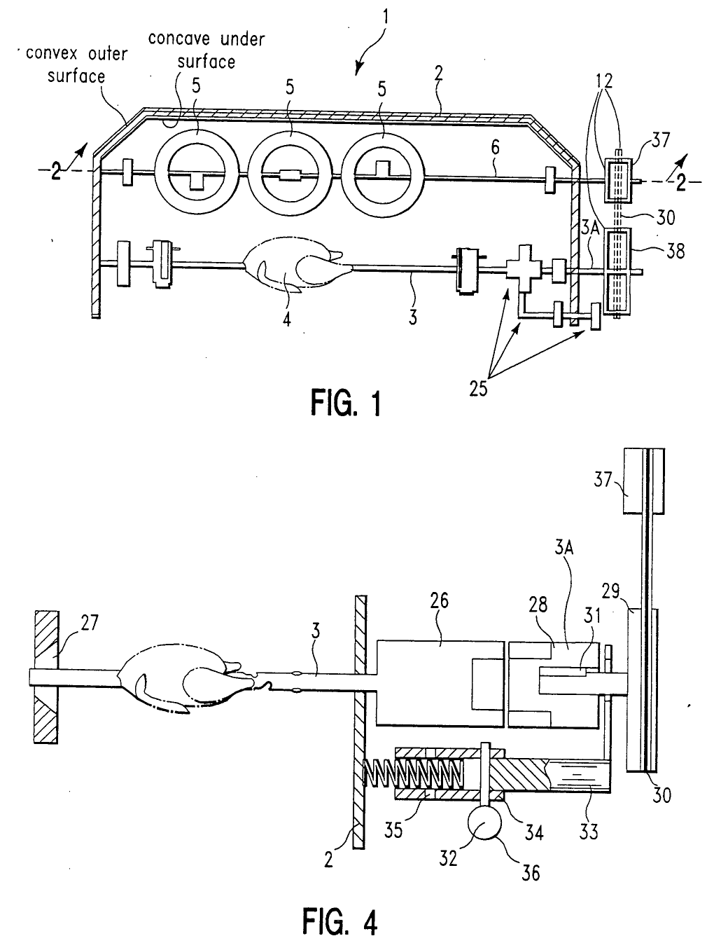

The preferred embodiments of the present invention will now be described with reference to FIGS. 1-3 of the drawings. Identical elements in the various figures are designated with the same reference numerals.

The rotisserie of the present invention is driven by a hot air thermal engine, which uses the heat provided for cooking to heat air in a closed chamber of a drive piston cylinder to turn the engine shaft of the engine, which rotates the spit of the rotisserie. Because the turning of the spit requires no electrical power, the rotisserie may be located where electrical power is not available, and thus is freely portable, a considerable convenience when cooking outdoors.

The thermal engine derives its power from at least two cylinders, preferably arranged side-by side, each cylinder having an air-filled chamber; a drive piston, displace-able by the air when heated; a drive piston rod connected to the drive piston and extending out of the chamber and through the wall of the cylinder to turn the engine shaft. In the preferred thermal engine, the cylinder also has an intake/exhaust valve. In this preferred three-cylinder design, the engine shaft is rotated in three phases of 120 degrees shift between reciprocating drive pistons. At the end of each reciprocating action, a relief valve is opened so that the hot air can escape and fresh air can enter the chamber of the cylinder. The valve is then shut before the next cycle begins. With a two-cylinder configuration, each cylinder may have a 90-degree phase operation.

The cylinders are preferably constructed from sections of tubing, preferably copper tubing, because of its good heat conductivity and heat capacity, at low-cost. In a preferred embodiment, the outer diameter of copper tube may be about 2.5 inches and its length about 6½ inches. The cylinder, or tubing, size is selected such that the volume of its inner chamber is significantly larger than the displaced volume created by the piston reciprocating action. Preferably, the volume of the cylinder is 10 times the volume of the air displaced. Variations in speed and torque of the thermal engine may be achieved with changes in chamber diameter (cylinder internal diameter), and length and volume displacement, determined by the length of the drive piston, and the drive piston diameter.

FIG. 1 illustrates a preferred embodiment of the present invention, wherein the hot air thermal engine and rotisserie spit are contained within the lid of an outdoor grill. The lid has a convex outer surface and a concave under surface, defining an area under the lid. The cylinders of the thermal engine, and the spit which it drives, are disposed under the lid, 2, of an outdoor cooking grill. The engine shaft, which connects the engine to the spit, is peripheral to the lid. If desired, the lid can be dimensioned to replace the lid of an existing outdoor grill. The rotisserie, shown generally at 1, provides a method for automatically turning the spit, 3, on which the food, 4, is cooked, providing a uniform and convenient cooking method. This is accomplished without an external power source, such as electricity, by using the heat generated for cooking. As shown in FIG. 1, the cylinders, 5, of the thermal engine are located above the spit, and beneath the lid.

The rotisserie spit may be constructed of two pieces, a shaft that connects to the engine shaft, and a detachable spit. This would permit the operator to detach the spit for insertion into the article the food to the cooked. Thereafter, the spit, with the food disposed thereon, can be re-attached to the shaft. The attachment of the spit to the shaft must be relied on to hold the weight of the food and to translate the rotation of the shaft, hence the connection of the spit to the shaft, must be fixed, and firm, but release-able.

Additionally, means, 25, are provided to quickly disconnect the shaft from the drive mechanism, stopping the rotary motion of the spit shaft and spit. The food can then be easily basted or inspected to see if it is adequately cooked, and easily agree attached to the drive mechanism. A still preferred embodiment of the quick disconnect means, 25 is illustrated and described in greater detail in relation to FIG. 4, below.

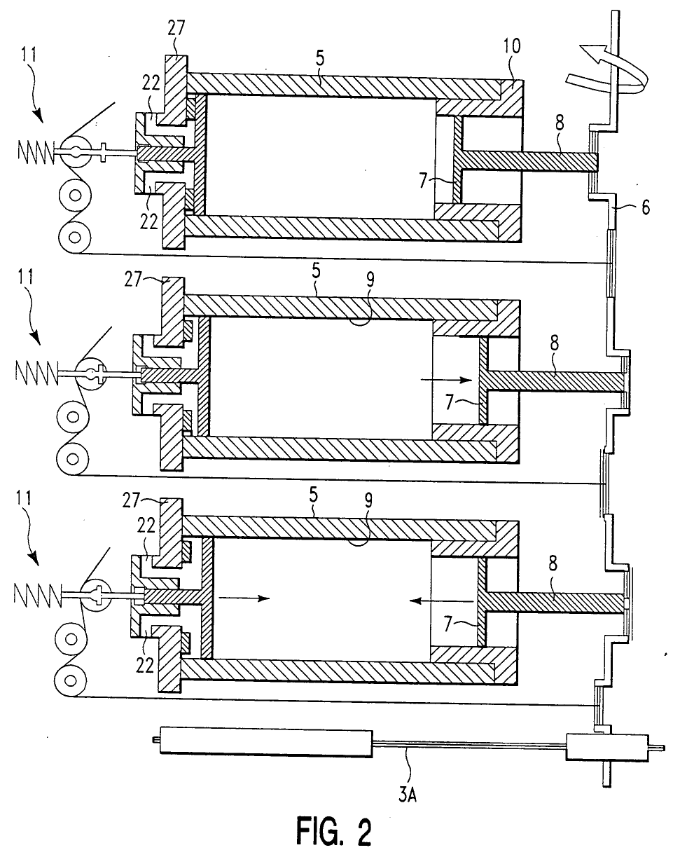

FIG. 2 illustrates the cylinders, 5, in cross sectional view along the lines 2-2 of FIG. 1. The cylinders are arranged in a parallel fashion and connected to an engine shaft, 6. Within the cylinders are chambers defined by the inner wall, 9, of the tubing. Within the chamber, a drive piston, 7, is connected to a piston rod, 8, by means of which the drive piston connects to the engine shaft. In operation the air within the chamber is heated by the heat used for cooking. The heated air pushes the drive piston and the rod to the right in FIG. 2. As shown in FIG. 2, a portion of the inner wall the chamber may be formed of a material such as stainless steel to provide a smooth surface for the drive piston.

According to a preferred embodiment of the invention, a stainless-steel insert may be used to form a smooth inner surface of the copper cylinder at the drive piston end, so that a graphite drive piston may be efficiently and reliably displaced, back and forth, within the cylinder chamber. Both the stainless steel and the graphite material are selected for their low friction properties and mechanical properties.

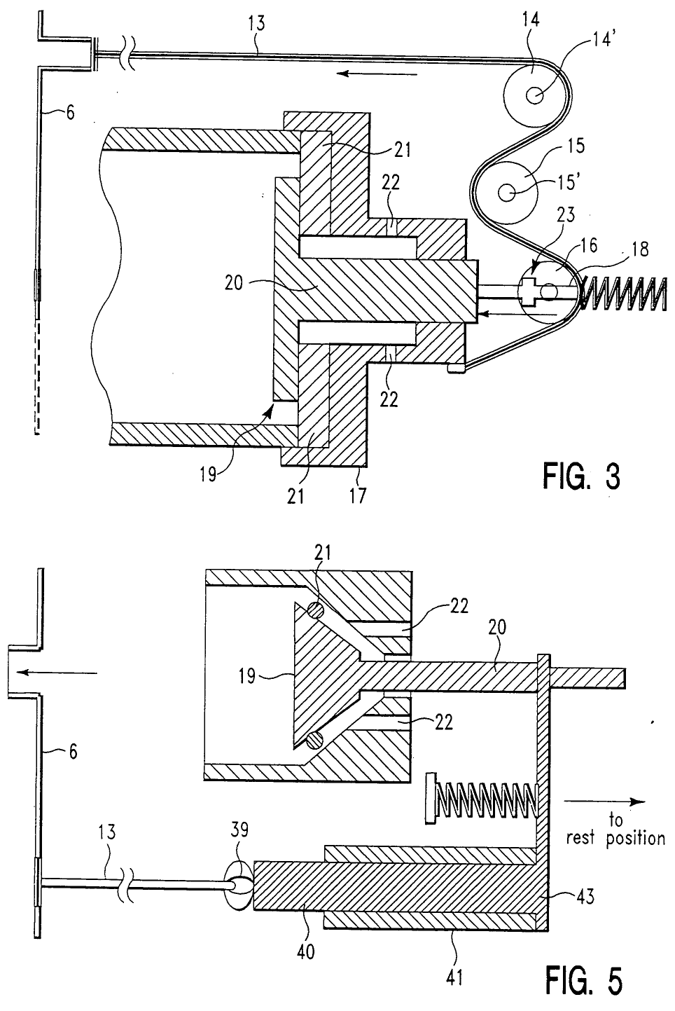

The exhaust/relief valves, shown generally at 11, are located at the other end of the cylinder from the engine shaft. The operation of the valves will be described in relation to FIG. 3. As seen in FIG. 1 the motion of the engine shaft is translated through means, 12, consisting here of engine shaft wheel, 37, pulley 30, and spit shaft wheel, 38, which translate that motion of the engine shaft into rotation of the spit shaft, 3A and spit, 3, at e.g., a 4:1 ratio. A still preferred embodiment of means, 12, is pictured and described in greater detail in relation to FIG. 4, below.

The preferred to sign for an outdoor barbecue grill is not concerned with efficiency as much as with simplicity, reliability and cost trade-off. However, the present invention is not limited to an outdoor grill, and other types of hot air piston cycle engines such as Sterling, Ericsson, Carnot, Joule or others, perhaps a derivative of the above described engine, can be used to improve the efficiency of the design for a particular cooking situation.

FIG. 3 depicts in greater detail the configuration and functioning of the spring loaded string anchors for the relief valves. As shown, a string, 13, is attached to the crank-shaft, with the main drive piston leading the exhaust valve mechanism by 90 degrees. From the engine shaft, 6, the string, 13, is routed through (about and around) three wheels (14, 15, and 16) to the end of the cylinder opposite the drive piston, shown here as end cap, 17. The first two wheels, 14 and 15, through which the string is routed are free to rotate around their axes, 14′ and 15′, respectively.

The third wheel, 16, is attached to a sliding rail, 18. As the engine shaft rotates, the string is pulled and the third wheel, 16, slides until the engager displaces the relief valve's piston, 19, opening the valve. The engager of the third, or sliding, wheel touches the rod of the relief valve piston only after full extension of the drive piston, 7, at the end of the volume expansion cycle. At the beginning of the volume expansion cycle, the heated air in the cylinder chamber expands, pushing the relief piston to the right, against the seal, 21, thus sealing the cylinder more tightly. At the end of the volume expansion cycle, the engine shaft, 6, pushes the relief valve rod, 20, against the spring.

The air in the chamber is released through the holes, 22, located in the outer dimension of the end cap. As the air pressure in the chamber approaches atmospheric pressure, fresh air at ambient temperature enters the chamber. This configuration enables one to control the amount of relief and intake by changing the length of the relief valve motion. As shown in FIG. 3, the valve is untouched for full 180 degrees of expansion (pulled back by the spring). The valve will not move until the wheel, 16, makes contact with the engager, 23. As the engager, 23, is pushed by the wheel, 16, the spring is loaded with potential energy that will be used during retraction to the rest position, away from the relief valve.

FIG. 4 illustrated a preferred embodiment of the quick disconnect means for disconnecting the sit from the rotary motion of the shaft. The means are shown in disengaged position. The spit is constructed with an enlarged handle, 26, for safe and easy insertion into the spit shaft. This handle is used also as a mating coupler. Once inserted into spit shaft 3A, the other end of the spit may extend beyond the wall of the rotisserie cover, and be guided into a conical guide, 27 and rested on the open slit of the cover. A mated sliding coupler, 28, is provided on the shaft. The shaft wheel, 29, is firmly attached to the shaft, which is driven by the pulley, 30. The coupler, 28, moves horizontally along the shaft's guide, 31, when the bolt, 32, pushes the engager, 33, against the spring. The bolt, 32, has two positions; the disengaged or disconnected position, and the engaged position (not pictured) when the bolt pin, 34, is brought to pin holder, 35. In operation, the user pulls up the bolt handle, 36, so that the pin, 34 is released from its disengaged position pin holder, and, by lifting the bolt to the left, the spit is engaged and follows the pulley's rotation. The pin is pushed down into pin holder position, 35, to secure the engagement. This arrangement provides for safe insertion, with the user's hands out of the heated cooking region. If desired, the handle maybe coated with a heat resisting material so that the spit can be picked up with bare hands.

An alternate spring loaded string anchor for the relief valves is shown in FIG. 5. One end of the string, 13, is attached to the engine shaft, 6. The other end is attached by hook attachment, 39, to a sliding shaft, 40, which moves within a guide tube, 41. The sliding shaft is firmly attached to the engager, 43, which is spring loaded against the wall of the lid, or cover, urging the shaft to the rest position as shown by the arrow. However, as the engine shaft rotates, it pulls the string, overcoming the spring force and sliding the shaft to the left. At the end of the drive piston cycle, the engager is at the position pictured, pushing the relief valve piston rod, 20, and piston, 19, inward, enabling hot air to escape from the cylinder through holes, 22, and for air at ambient temperature to enter the chamber's cylinder. In this configuration, the drive piston is leading the relief action by 90 degrees. The relief piston, 19, pictures is of a cone shape. The selected angle of about 15 degrees for this design allows wide tolerance in machining while maintain good sealing, however, other angles or no angle will work as well. As the engine shaft continues to turn, the tension on the string decreases, and the spring urges the piston rod, 20 and piston, 19, against the seal, shown here as an O ring, sealing the cylinder.

There has thus been shown and described a novel portable rotisserie with a heat-powered spit, which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A rotisserie for a cooking grill having a heat source creating a heated cooking region, the rotisserie comprising:
a) hot air engine, adjacent the heated cooking region, said engine turning an engine shaft peripheral to the heated cooking region, said rotisserie further comprising,
b) a spit, disposed within the heated cooking region, and fixedly connected to a spit shaft extending peripherally of the cooking region, and attached to the engine shaft, such that the turning of the engine shaft rotates the spit shaft and spit.

2. A rotisserie as in claim 1, wherein the hot air engine comprises at least one cylinder, each cylinder comprising an air filled chamber with a drive piston displace-able within the chamber when the air is heated, each drive piston attached to a drive piston rod, which extends through the wall of the cylinder, to make a pivot-able connection to the engine shaft, such that the phased displacement of the drive pistons of the cylinders turns the engine shaft, which rotates the spit shaft.

3. A rotisserie comprising a heat source for creating a heated cooking region, a hot air engine comprising at least cylinders, each cylinder comprising an air-filled chamber disposed adjacent the heated cooking region, said air filled chamber further comprising a drive piston displaceable within the chamber when the air is heated, each drive piston connected to a drive piston rod which extends through the wall of the cylinder, to make a pivot-able connection to an engine shaft peripheral to the cooking region, such that the phased displacement of the drive piston rods turns the engine shaft, and a spit shaft, fixedly connected to a spit disposed within the cooking region, said spit shaft extending to, and attached to the engine shaft such that turning of the engine shaft rotates the spit shaft.

4. A rotisserie comprising a spit shaft geared to the engine shaft of a hot air engine comprising at least two air-filled cylinders, each cylinder having a drive piston displace-able by heated-air, each drive piston connected to a drive piston rod which extends through the wall of the cylinder to make a pivot-able connection to the engine shaft, such that the phased displacement of the drive piston rods turns the engine shaft, which rotates the spit shaft.

5. A rotisserie within the lid of a cooking grill having a heat source for heating a cooking region, the rotisserie comprising the rotisserie of claim 1.

6. A thermal driven spit for cooking, the spit being driven by the heat supplied for the cooking.

7. A rotisserie as in claim 5, wherein the engine is secured within the lid such that it will lie adjacent the cooking region when the lid is disposed over the heat source.

8. A rotisserie as in claim 5, wherein the spit shaft is connected to the engine shaft through a series of gears.

9. The rotisserie of claim 2, further comprising a relief valve through a wall of the cylinder at the end opposite the drive piston, which opens after the drive stroke of the drive piston, to exhaust the heated air and to take in air at ambient temperature.

10. The rotisserie of claim 5, further comprising a relief valve through a wall of the cylinder at the end opposite the drive piston, which opens-after the drive stroke of the drive piston, to exhaust the heated air and to take in air at ambient temperature.

11. The rotisserie of claim 9, further comprising a spring loaded string anchor for the relief valves.

12. The rotisserie of claim 10, further comprising a spring loaded string anchor for the relief valves.

13. The rotisserie of claim 11, wherein the relief valve further comprises a relief valve piston attached to a piston rod, and the spring loaded string anchor comprises:
a string attached to the engine shaft, and wound between,
two wheels rotatable on their respective axes, which define a line generally parallel to the engine shaft, and past the opposite end of the cylinder from the engine shaft, and,
a third wheel, rotatable on its center axis, which is disposed on a slide bar, the outer end of which lies on the said line, said string wound about the third wheel and attached to the end of the cylinder opposite the drive piston, and
a spring disposed adjacent the third wheel and generally perpendicular to the said line, and attached to the third wheel to urge it away from the cylinder, maintaining the relief valve in a closed position, and,
an engager disposed between the center axis of the third wheel and the cylinder, and capable of displacing the relief valve piston rod, and thereby the piston, so as to open the relief valve when the string tension overcomes the spring and the third wheel moves down the slide bar.

14. The rotisserie of claim 12, wherein the relief valve further comprises a relief valve piston attached to a piston rod, and the spring loaded string anchor comprises:
a string attached to the engine shaft, and wound between,
two wheels rotatable on their respective axes, which define a line generally parallel to the engine shaft, and past the opposite end of the cylinder from the engine shaft, and,
a third wheel, rotatable on its center axis, which is disposed on a slide bar, the outer end of which lies on the said line, said string wound about the third wheel and attached to the end of the cylinder opposite the drive piston, and
a spring disposed adjacent the third wheel and generally perpendicular to the said line, and attached to the third wheel to urge it away from the cylinder, maintaining the relief valve in a closed position, and,
an engager disposed between the center axis of the third wheel and the cylinder, and capable of displacing the relief valve piston rod, and thereby the piston, so as to open the relief valve when the spring tension overcomes the spring and the third wheel moves down the slide bar.

15. The rotisserie of claim 11, wherein the relief valve further comprises a relief valve piston attached to a piston rod, and the spring loaded string anchor comprises:
a string having one end attached to the engine shaft, and the other end attached to a sliding shaft, moveable within a guide tube, attached to the rotisserie generally perpendicular to the engine shaft, said sliding shaft firmly attached to an engager, spring loaded away from the rotisserie, said engager attached to the relief piston rod, and capable of displacing the relief valve piston rod, and thereby the piston, so as to open the relief valve when the sting tension overcomes the spring and the sliding shaft moves through the guide tube.

16. The rotisserie of claim 12, wherein the relief valve further comprises a relief valve piston attached to a piston rod, and the spring loaded string anchor comprises:
a string having one end attached to the engine shaft, and the other end attached to a sliding shaft, moveable within a guide tube, attached to the rotisserie generally perpendicular to the engine shaft, said sliding shaft firmly attached to an engager, spring loaded away from the rotisserie, said engager attached to the relief piston rod, and capable of displacing the relief valve piston rod, and thereby the piston, so as to open the relief valve when the sting tension overcomes the spring and the sliding shaft moves through the guide tube.
